(19) United States
(12) Patent Application Publication
(10) Pub. No.: US 2006/0155813 A1
(43) Pub. Date: Jul. 13, 2006

(54) Instant messaging communications network with selectable responses to active status queries, made to individual user display stations by other user stations, personalized to such other querying user stations

(75) Inventors: Timothy Alan Dietz, Austin, TX (US); Walid M. Kobrosly, Round Rock, TX (US); Nadeem Malik, Austin, TX (US); Avijit Saha, Somers, NY (US)

Correspondence Address: IBM CORPORATION;INTELLECTUAL PROPERTY LAW, 11400 BURNET ROAD, AUSTIN, TX, 78758, US

(73) Assignee: International Business Machines Corporation, Armonk, NY (US)

(21) Appl. No.: 11/034,267

(22) Filed: Jan. 12, 2005

(51) Int. Cl. G06F 15/16

(52) U.S. Cl. 709/207; 709/225

(57) ABSTRACT

A network distribution network for instant messaging including a plurality of display stations operated by a group of users enabled to send and receive displayable messages to other group members comprising storage for each individual station in the plurality of display stations for storing a list of identified other display stations authorized for instant message exchange with users at these display stations in combination with standard means at each individual station in the group of display stations enabling a user at the individual display station to activate such individual station for instant message exchange. There is a conventional implementation at each individual station of the plurality of display stations for querying as to whether a selected other display station operated by a user in the group is activated. However, in response to such a status query there are provided means at each individual user operated display station for making a selected status response personalized to the identified display station. There are means at each individual station of the plurality of display stations for displaying the stored list of authorized other identified display stations and the status of each of the other identified user operated display stations including any instant message relative to such status. There also may be provided at each individual user operated station in the plurality of display stations an implementation for displaying the stored list of authorized other identified display stations, including any personalized status response sent from the individual station to any of said other identified display stations.

### TECHNICAL FIELD

The present invention relates to computer managed communication networks, such as the World Wide Web (Web) or like private intranet networks that distribute electronic messages transmitted to users who may log on at a variety of display terminals or stations, and particularly to instant messaging systems using such networks.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents. The Web or Internet, which had quietly existed for over a generation as a loose academic and government data distribution facility, reached “critical mass” and commenced a period of phenomenal expansion. With this expansion, businesses and consumers have direct access to all matter of documents and media through the Web.

The availability of extensive distribution channels has made it possible to keep all necessary parties in business, government and public organizations completely informed of all transactions that they need to know about at almost nominal costs through conventional electronic mail.

Among the many and varied industry efforts to focus the user's attention on the mail and mail sources most significant to a user from among the many available to him has been instant messaging. In an instant messaging system, a user may log in at any individual display terminal on a network and join a select group of other users logged in at other like display terminals to form a set of users at terminals that are, in effect, interconnected at server levels in networks for communications. International Business Machines Corporation's Lotus Sametime product line is an example of such an instant messaging system. The selected set of participants in any instant messaging network are people with special common, but often limited, interests, e.g. a set of close friends, a family, business partners, a business team, a group of sports or game players, an education study group. The purpose of such an instant messaging team or group is real-time textual conversations within the group including an awareness of who is on-line, i.e. active. Thus, inherent in any instant messaging system is the capability to instantly query as to what users/display stations are on-line or active.

### SUMMARY OF THE PRESENT INVENTION

The present invention recognizes that in addition to being aware of which other members are on-line or active, there is a need on the part of some members to selectively give some members in the instant messaging group information that may be personal to such individuals and of little interest to other members in the set or group. Accordingly, this invention provides a distribution network for instant messaging including a plurality of display stations operated by a plurality of identified users to send and receive displayable messages that has a system comprising storage, available to each individual identified instant message user operated station in the plurality of display stations, for storing a list of other identified user operated display stations authorized for instant message exchange with the user operating the individual display station in combination with standard means at each individual station in the group of display stations enabling an identified instant user at the individual display station to activate such individual station for instant message exchange. There is a conventional implementation at each individual instant user station of the plurality of instant user display stations for querying as to whether a selected other instant user operated display station is activated. However, in response to such a status query there are provided means at each individual instant user operated display station for making a selected status response personalized to the identified instant user making the inquiry. There are means at each individual instant user operated station for displaying the stored list of authorized other identified instant users in the group and the status of each of the other identified instant user including any instant message relative to such status received from the user. There also may be provided, at each individual instant user operated station in the plurality of instant user operated display stations, an implementation for displaying the stored list of other identified instant users in the group of display stations, including any personalized status response sent from the individual instant user operated station to any of the other identified instant user operated display stations.

The selected instant message status response to a status query may be predetermined and stored in association with the specific instant message user at an individual display station. This instant message status response may also be time-determined. For example, there may be means for storing the calendar of a user at the display station whereby the time-determined message status response is based upon this calendar.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the interactive display terminals, as well as servers in the instant messaging network of this invention;

FIG. 2 is a generalized view of a Web or Internet network that may be used for instant messaging distribution in the practice of the present invention;

FIG. 3 is a diagrammatic illustration of an interactive display interface used for the group of instant messaging friends shown for an active or ON instant message display user and the active or ON status of such friends for instant messaging including any personalized status response sent out to such friends by the terminal user;

FIG. 4 is the display interface of FIG. 3 further including any personalized status response received at this shown user terminal display from any of the other friends in the group;

FIG. 5 is an illustrative flowchart describing the setting up of the functions to form the instant messaging status responses in accordance with the present invention; and

FIG. 6 is a flowchart of an illustrative run of the program set up according to FIG. 5.

### DETAILED DESCRIPTION OF THE PREFERRED EMBODIMENT

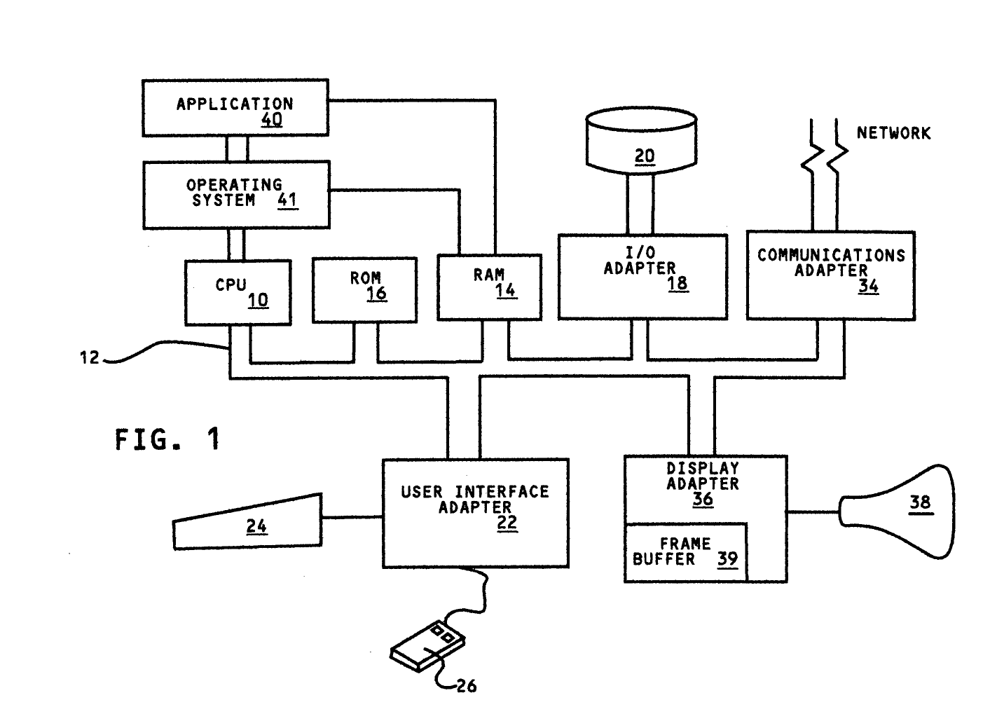

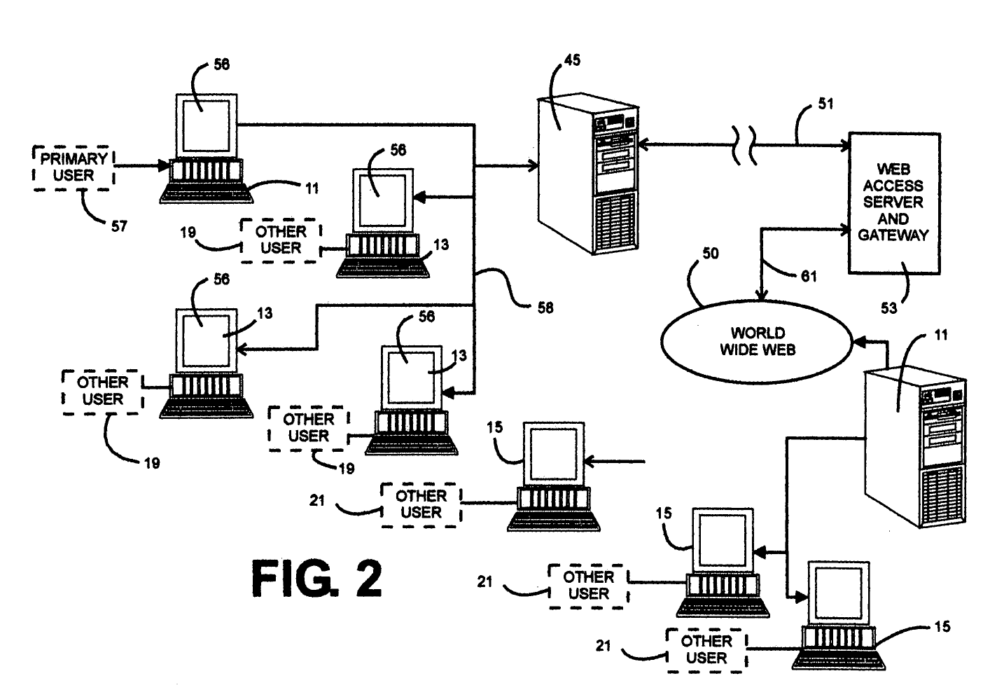

Referring to FIG. 1, a typical data processing system is shown that may function as the computer controlled network terminals or Web terminals or stations used conventionally as any of the sending or receiving stations for instant messaging transmissions. The system shown is also illustrative of any of the server computers used for the instant message distribution to be described in greater detail with respect to FIG. 2.

A central processing unit (CPU) 10, may be one of the commercial microprocessors in personal computers available from International Business Machines Corporation (IBM) or Dell Corporation; when the system shown is used as a server computer at the Web distribution site to be subsequently described, then a workstation is preferably used, e.g. RISC System/6000® (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows XP™ or Windows2000™, as well as UNIX and IBM AIX operating systems. Application programs 40, controlled by the system, are moved into and out of the main memory Random Access Memory (RAM) 14. These programs include the programs of the present invention for enabling the personalized responses to instant messaging status queries from other users at display stations in the group. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the network in order to access instant messages. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective, the various elements and methods that may be related to the present invention. Since a major aspect of the present invention is directed to instant messaging documents transmitted over networks, an understanding of networks and their operating principles would be helpful. We will not go into great detail in describing the networks to which the present invention is applicable. Reference has also been made to the applicability of the present invention to a network, such as the Internet. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers. Instant messaging, as will be described with respect to FIG. 2, may be distributed through a local network, e.g. an intranet, or through the Internet.

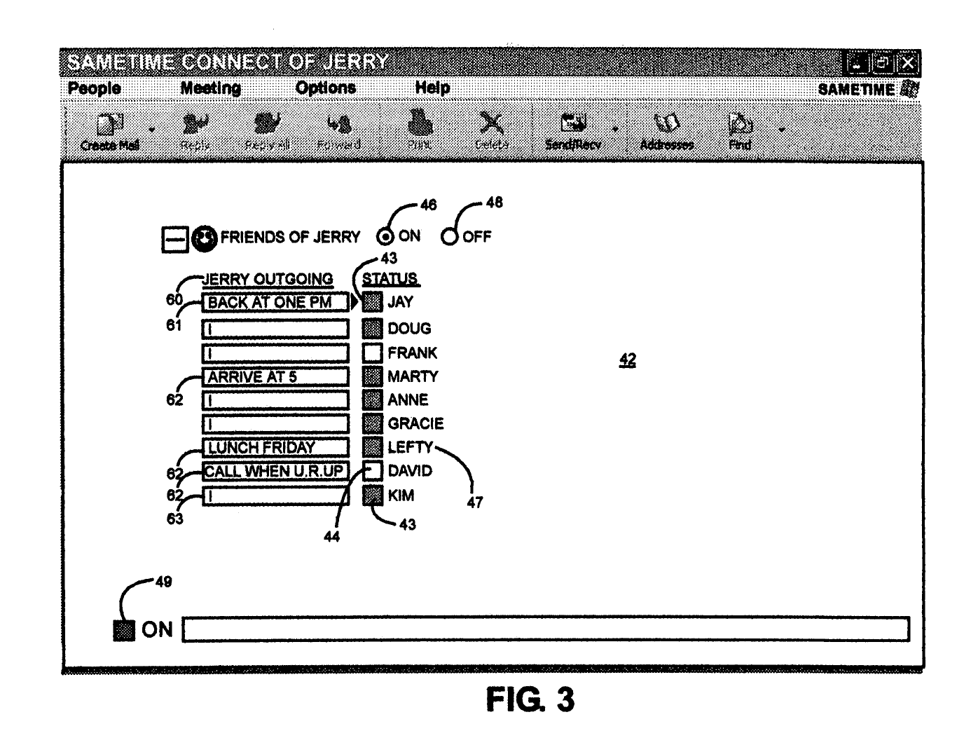

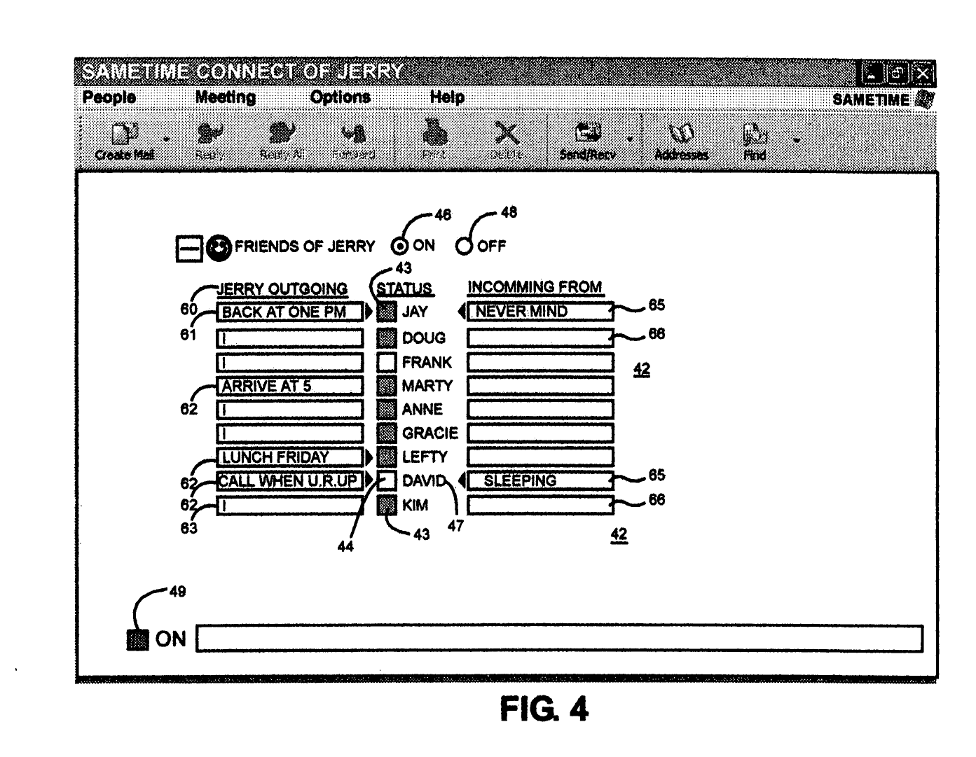

A generalized diagram of both an intranet portion and a Web or Internet portion is shown to illustrate the instant mail distribution system of the present invention in FIG. 2. The first instant messaging user group that will subsequently be used in connection with FIGS. 3 and 4, is an intranet group with primary user 57 (for purposes of illustration) operating display 56 station or terminal 11 connected for instant messaging through server 45 with other users 19 respectively connected through other user controlled stations 13 to server 45 in a conventional instant messaging arrangement. The instant messaging group may be more global wherein server 45 is connected through a Web/Internet access server 53 and an appropriate gateway, connector 61 via the Web 50 to another instant messaging system including a set of further other users 21 operating through display stations 15 for instant messaging through server 11. In this manner, the illustrative display of FIGS. 3 and 4 covers a primary user 57 connected in an intranet to other users 19 and via the Web to other users 21 through the display interfaces to be described. Reference may be made to the above-mentioned Mastering the Internet, pp. 136-147, for typical connections between local display stations to the Web via network servers, any of which may be used to implement the system on which this invention is used.

Within this network set up, we will now consider the illustrative instant messaging with personalized status responses to be described with respect to FIGS. 3 and 4. In FIG. 3, there is illustrated a display panel for instant messaging receiving/sending of Jerry one of an instant messaging group of conventionally listed friends 47. The other friends, i.e. members of the group, are listed 47, and the status of each shown in their respective status boxes either shaded 43 for ON or clear 44 for OFF. Jerry, as all of the friends group, may click himself OFF 48 or ON 46. He has presently clicked himself ON 46 (via a mouse input)>Jerry's ON state is indicated by his own status box 49 being shaded ON. Of course, on the corresponding display panels of each of Jerry's nine listed friends, Jerry's status box on each corresponding list 47 will be ON 43.

In accordance with this invention, in addition to selecting his on/off status selection, Jerry is enabled via a set 60 of Outgoing Response boxes 61 to enter a special personalized response for each of his listed set of friends. He has entered a personalized status response 62 for some friends and none 63 for others. Jerry's status including the status message, if any, will be appropriately presented and displayed at the display panels at each of the instant messaging group.

An illustrative example of such a presentation of the collective personalized status responses that may be used for each of the friends instant messaging is shown in FIG. 4, which is the display panel of FIG. 3 modified to conveniently show status input to Jerry from each of his instant message group of friends 47. There are two friends who have sent Jerry a status response 65 personalized for Jerry while the remainder have not personalized 66.

It should be noted that, as will hereinafter be further described, the personalized status responses may either be formed directly by the individual instant messaging group member for any specific other group member status query, or the personalized response may be predetermined and stored. In the latter instance, the personalized response may even be dynamically generated, e.g. from the individual members on-line calendar.

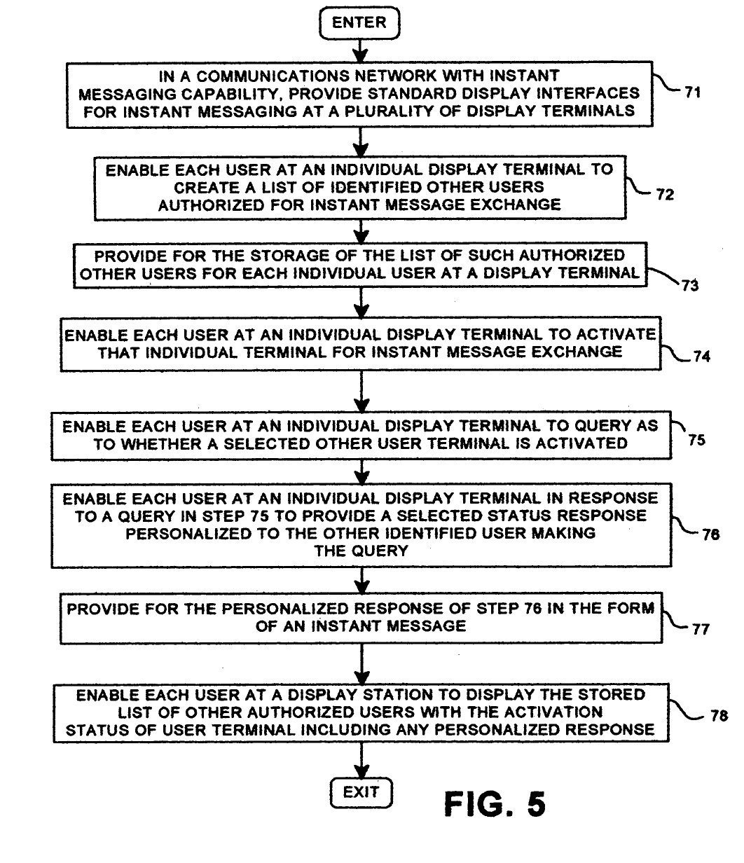

FIG. 5 is a flowchart showing the development of a process according to the present invention for enabling individual members of an instant messaging group to send status query responses to other group members personalized to that specific group member. In any standard instant messaging network system, enabling group members operating display terminals to distribute instant messaging to specified recipients, there is provision made for a conventional instant messaging group via a plurality of display terminal interfaces respectively operated by each member of the instant messaging group, step 71. Each individual group member is enabled to create at his terminal display interface, a list of other identified display member terminals authorized for this groups' instant messaging exchange, step 72. Provision is made for the storage of this respective list of such authorized group members at a server available to each individual member display terminal, step 73. Each group member or user at each individual display terminal is enabled to activate that terminal for instant messaging, step 74. Each group member or user at each individual display terminal is enabled to query as to whether a selected other authorized terminal is activated, step 75. Each group member or user at each individual display terminal, in response to a query in step 75, is enabled to provide a selected status response personalized to the other identified display terminal making the query, step 76. There is provision for making the personalized status query response of step 76 in the form of an instant message, step 77. Each user at each respective display terminal is enabled to display the stored list of other authorized display terminals with the activation status of terminal including any such personalized response, step 78.

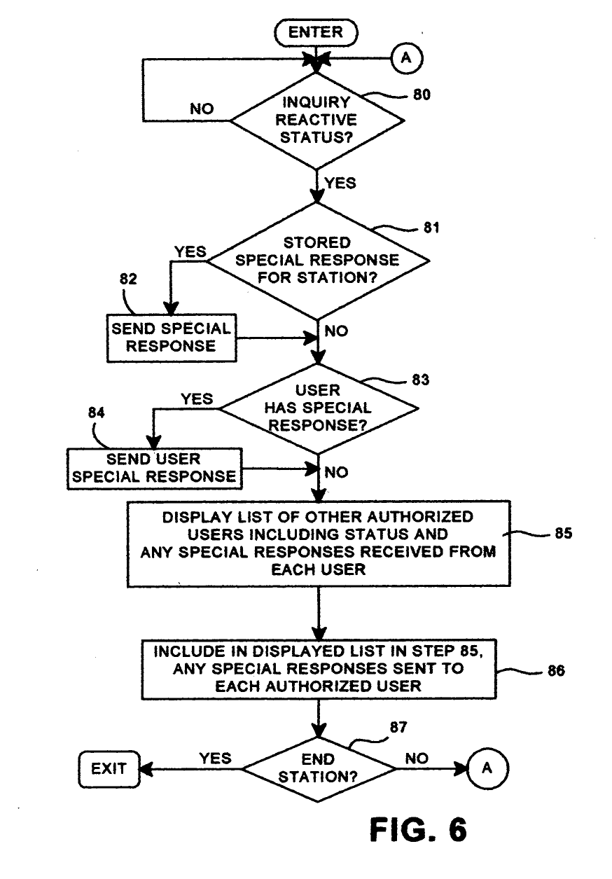

A simplified run of the process set up in FIG. 5 and described in connection with FIGS. 3 and 4 will now be described with respect to the flowchart of FIG. 6. At the display terminal of the instant messaging user there is provided an interface such as that of FIGS. 3 and 4. Let us assume that in the system to be described, that a group of members is set up for instant messaging. First, a determination is made, step 80, as to whether, at the individual display terminal operated by the group member being monitored, there is a status request from one of the other authorized member/user terminals in the group. If No, then an inquiry is awaited. If Yes, there is a status inquiry, a further determination is made as to whether there is a stored, i.e. predetermined special, response for the this status inquiry for the specific member station, i.e. terminal making the inquiry, step 81. If Yes, that stored special response is sent, step 82. Then, or if the decision in step 81 had been No, the user is enabled or prompted to make any specific response to this status inquiry from this status requesting terminal, step 83. If Yes, the user generated special response is sent along with the status indication, step 84. Then, or if the determination in step 83 had been No, there is displayed a list of other authorized user/member terminals in the instant messaging group including their status and any special responses received from such other terminals in response to status queries from the instant individual display terminal, step 85; this is essentially what is illustrated in FIG. 3. The user may optionally include in the displayed list of step 85, any special or personalized activation query responses sent from the instant individual display station to specific terminals in response to queries made from such other terminals, step 86; this is essentially what is illustrated in FIG. 4. At this point, a determination may conveniently be made as to whether any conventional instant messaging session being carried on incidentally to the status query processing of this invention is at an end, step 87. If Yes, the process is exited. If No, the process is branched back to initial step 80 as indicated by branch “A”.

One of the preferred implementations of the present invention is in application program 40 made up of programming steps or instructions resident in RAM 14, FIG. 1, of Web server computers during various Web operations. Until required by the computer system, the program instructions may be stored in another readable medium, e.g. in disk drive 20, or in a removable memory, such as an optical disk for use in a CD ROM computer input, or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In an instant messaging communication network including a plurality of display stations operated by a plurality of users to send and receive displayable messages, a system for controlling the instant messaging comprising:
means for storing a list of a plurality of identified users authorized for instant message exchange through user display stations operated by said users;
means at each identified user operated station enabling said user to activate said identified user station for instant message exchange;
means at each identified user operated station of said plurality of user display stations for querying as to whether a selected other identified user operated display station is activated; and
means at each individual identified user display station, responsive to a status query from another of said identified user operated display stations, for providing a selected status response personalized to the other identified user operated display station.

2. The instant messaging network system of claim 1 wherein said selected personalized status response is an instant message.

3. The instant messaging network system of claim 2 further including means at each individual identified user operated display station for displaying the stored list of authorized other identified user operated display stations and the status of each of said other identified user display stations including any instant message relative to said status.

4. The instant messaging network system of claim 2 further including means at each individual identified user operated display station for displaying the stored list of authorized other identified user display stations, including any personalized status response sent from said individual station to any of said other identified user operated display stations.

5. The instant messaging network system of claim 2 wherein said selected instant message status response is predetermined and stored for each identified user operated display station.

6. The instant messaging network system of claim 5 wherein said selected instant message status response is time-determined.

7. The instant messaging network system of claim 6 further including:
means for storing the calendar of an identified user operating said individual display station; and
whereby said time-determined message status response is based upon said calendar.

8. In an instant messaging communication network including a plurality of display stations operated by a plurality of users to send and receive displayable messages, a method for controlling the instant messaging comprising:
storing a list of a plurality of identified users authorized for instant message exchange through user display stations operated by said users;
enabling an identified user operating a display station to activate said identified user station for instant message exchange;
querying at each identified user operated station of said plurality of user display stations as to whether a selected other identified user operated display station is activated; and
responsive to a status query from another of said identified user operated display stations, providing from each individual identified user operated display station, a selected status response personalized to the other identified user operated display station.

9. The instant messaging method of claim 8 wherein said selected personalized status response is an instant message.

10. The instant messaging method of claim 9 further including the step of displaying the stored list of authorized other identified user operated display stations and the status of each of said other identified user display stations including any instant message relative to said status at each individual identified user operated display station.

11. The instant messaging method of claim 9 further including the step of displaying the stored list of authorized other identified user display stations, including any personalized status response sent from said individual station to any of said other identified user operated display stations at each individual identified user operated display station.

12. The instant messaging method of claim 9 wherein said selected instant message status response is predetermined and stored for each identified user operated display station.

13. The instant messaging method of claim 12 wherein said selected instant message status response is time-determined.

14. The instant messaging method of claim 13 further including:
the step of storing the calendar of an identified user operating said individual display station; and
whereby said time-determined message status response is based upon said calendar.

15. A computer program having code recorded on a computer readable medium for controlling the instant messaging in an instant messaging communication network including a plurality of display stations operated by a plurality of users to send and receive displayable messages comprising:
means for storing a list of a plurality of identified users authorized for instant message exchange through user display stations operated by said users;
means at each identified user operated station enabling said user to activate said identified user station for instant message exchange;
means at each identified user operated station of said plurality of user display stations for querying as to whether a selected other identified user operated display station is activated; and
means at each individual identified user display station, responsive to a status query from another of said identified user operated display stations, for providing a selected status response personalized to the other identified user operated display station.

16. The computer program of claim 15 wherein said selected personalized status response is an instant message.

17. The computer program of claim 16 further including means at each individual identified user operated display station for displaying the stored list of authorized other identified user operated display stations and the status of each of said other identified user display stations including any instant message relative to said status.

18. The computer program of claim 16 further including means at each individual identified user operated display station for displaying the stored list of authorized other identified user display stations, including any personalized status response sent from said individual station to any of said other identified user operated display stations.

19. The computer program of claim 16 wherein said selected instant message status response is predetermined and stored for each identified user operated display station.

20. The computer program of claim 19 wherein said selected instant message status response is time-determined.

21. The computer program of claim 20 further including:
means for storing the calendar of an identified user operating said individual display station; and
whereby said time-determined message status response is based upon said calendar.
